(19) United States
(12) Patent Application Publication
(10) Pub. No.: US 2002/0066385 A1
(43) Pub. Date: Jun. 6, 2002

(54) Method for removing a thin deformable sheet

(76) Inventor: Lon McIlwraith, Delta (CA)

Correspondence Address: Dan Gelbart, 3700 Gilmore Way, Burnaby, BC, V5G 4M1, CA

(21) Appl. No.: 09/729,786

(22) Filed: Dec. 6, 2000

(51) Int. Cl. B41F 35/00; B41L 41/00; B41F 1/00

(52) U.S. Cl. 101/479; 101/425

(57) ABSTRACT

In accordance with the present invention two concentric cylinders, that are mutually rotatable about their common axis, employ two evacuated slots to lift a thin deformable sheet away from either surface of a flat sheet to which it is adhering. The thin deformable sheet is then drawn into the joint evacuated orifice presented by the two aligned slots. These two concentric cylinders are then rotated such that the thin deformable sheet is gripped between opposing edges of the two slots. Having gained purchase of the thin deformable sheet, the method is completed by the removal of the thin deformable sheet over a distance.

### BACKGROUND OF THE INVENTION

In the commercial printing industry, an important step in the preparation of images for printing is the transfer of image information to a substrate that can then be used repeatedly to print the image. While the substrate can take a variety of forms, one of the most extensively used forms is the printing plate, a flat sheet of material with a surface that can be modified in order to selectively retain or repel ink. In general, the modifiable surface is the result of a special coating, commonly referred to as an emulsion, which is a radiation-sensitive coating that changes its properties when exposed to radiation such as visible, ultraviolet, or infrared light. This coating sits on the surface of base sheet, which itself may be composed of a variety of materials such as aluminum, polyester, or rubber.

The transfer of image information to a printing plate can be done in a variety of ways. A long-established method is to transfer the image first to a photographic film, and then use the photographic film in order to selectively expose parts of the printing plate to radiation (e.g., visible light), thereby transferring image information to the plate. With the increasing use of information technologies in the graphic arts industry, however, this film-based method is less than efficient for printing images that are stored as computer files. A more recent approach, commonly known as CTP or Computer to Plate, takes advantage of the efficiencies inherent in computerization by transferring the image information directly to the printing plate, eliminating the intermediate step of transferring the image to a photographic film.

The advent of CTP technology is part of an increasing trend towards automation in the printing industry. The increasing use of information technology to create and distribute electronic and print publications, coupled with the more widespread accessibility of such technologies, is contributing to a greater demand for shorter print runs and faster turnaround times. These changes, in turn, have contributed to a greater push toward automating all aspects of the printing process.

Automating the printing industry does present some special technological hurdles, however. In the case of printing plates, some of these hurdles result from the delicacy of the unexposed emulsion-coated surfaces of these plates. These surfaces are easily marred, and if marred, create undesirable defects in the final printed product. Any attempt to automate the handling of printing plates must thus include measures to prevent damage to the delicate printing surfaces of the unexposed plates.

Measures used to reduce marring of plates during storage or transport, however, introduce additional problems for automation. Unexposed plates are normally supplied in packages of 25 to 100 with interleaf sheets, more commonly referred to as slip sheets, between the plates. These sheets, which may be made of a variety of materials, are used to protect the sensitive printing surfaces of the plates by providing a physical barrier between the emulsion on one plate and the surface of another plate. The slip sheets must be removed from the printing plates prior to imaging.

The need to move sheets of various materials by automated means is not a new problem, and various satisfactory methods for handling sheets have been developed for a number of contexts and industries. The garment industry, for example, uses various combinations of mechanical and vacuum techniques to pick sheets of textile from the top or bottom of stacks. Off ice equipment such as photocopiers and printers also employ various means to move individual sheets of paper from a larger stack, commonly employing friction between rollers and paper surfaces to engage and transport sheets. Within the printing industry, commercial printing presses have long employed similar methods to rapidly feed sheets of paper into sheet-fed printing presses. A long established solution for this context is involves using flexible suction (vacuum) cups in association with other devices to pick up individual paper sheets.

However, the automation of slip sheet removal for the printing industry presents a number of special problems. For one thing, in contrast to the examples described above, slip sheet removal is not simply a matter of moving a single sheet from a stack of similar sheets. In general, slip sheets are made of materials different from those used for printing plates, and are further differentiated by being substantially thinner, lighter, and less rigid than the plates they separate. These characteristics also make slip sheets more deformable than their neighboring printing plates. Removing a sheet of thin, lightweight, and relatively deformable material sandwiched between heavy plates is a technological challenge further complicated by the fact that the slip sheets must be removed without damaging the surfaces of the printing plates. The removal process can also be complicated by the fact that slip sheets and plates are often quite large (at present, very large format printing plates can be as large as 58″×80″, with correspondingly large sizes for the intervening slip sheets), while the slip sheet materials themselves can be fragile and easily torn. In addition, the actual materials used for slip sheets can vary, although commonly the slip sheet material is paper.

Another problem is that slip sheets tend to adhere to printing plate surfaces when plates are separated from each other. As a result, the exact position of the slip-sheet relative to a plate is not consistent. A slip sheet can adhere to the bottom of a printing plate as it is moved away from its neighboring plate; it may also adhere to the top of a plate. The tendency of the slip sheets to adhere also complicates removal, especially since the sheets must be separated from printing plate surfaces without scratching, touching, or otherwise damaging the emulsion-coated surfaces of the plates. Since the emulsions are very delicate, any mechanical impact imposed upon the surface of the plate is a potential source of damage, even if it occurs through a slip sheet.

A possible means of addressing this problem is to use suction cups to remove the slip sheets. The use of a vacuum is particularly attractive as it has the potential to eliminate unwanted contact with the mechanically sensitive surfaces of the printing plates. A vacuum can be used to draw slip sheets into a desired position from one side without requiring mechanical contact to move the slip sheet, reducing the possibility that the picking mechanism might touch the surface of the printing plate. Suction cups have been successfully used in other contexts, for example, to move paper in sheet-fed presses.

However, vacuum methods employing suction cups tend to fail with slip sheets for a number of reasons:

1. Slip-sheets often are sufficiently porous that a suction cup cannot achieve sufficient vacuum to lift the slip-sheet;

2. The slip-sheet porosity can lead to a suction cup gripping the non-porous printing plate below, through the slip-sheet, and lifting both together;

3. Slip-sheets can be very large in some applications, such that it may be lifted by a suction cup, but cannot be moved laterally without releasing the slip-sheet;

4. Flexible suction cups have very little peripheral stiffness on their own and rely on the stiffness of the object being picked up to maintain a good seal around the edge of the cup, and to prevent the cup collapsing on itself. Slip-sheets rarely provide sufficient stiffness to permit a reliable gripping mechanism, and are prone to wrinkling at the interface between suction cup and slip-sheet, causing vacuum failure and premature release.

It is an object of the present invention to provide a method of reliably removing slip sheets without causing damage to the surfaces protected by the slip sheets, and which also addresses the possibility that the position of a slip sheet may vary due to its tendency to adhere to neighboring surfaces.

### BRIEF SUMMARY OF THE INVENTION

In accordance with the present invention two concentric cylinders, that are mutually rotatable about their common axis, employ two evacuated slots to lift a thin deformable sheet away from either surface of a flat sheet to which it is adhering. The thin deformable sheet is then drawn into the joint evacuated orifice presented by the two aligned slots. These two concentric cylinders are then rotated such that the thin deformable sheet is gripped between opposing edges of the two slots. Having gained purchase of the thin deformable sheet, the method is completed by the removal of the thin deformable sheet over a distance.

### BRIEF DESCRIPTION OF THE DRAWINGS

FIG. 1 depicts an arrangement of two mutually concentric and evacuated cylinders, each with a slot.

FIG. 2A depicts the operation by which the arrangement in FIG. 1 is used to lift a thin deformable sheet away from a mechanically sensitive flat sheet.

FIG. 2B depicts the operation by which the arrangement in FIG. 1, having executed the step in FIG. 2A, grips the thin deformable sheet between two opposing faces of slots in the cylinders.

### DETAILED DESCRIPTION OF THE PREFERRED EMBODIMENT

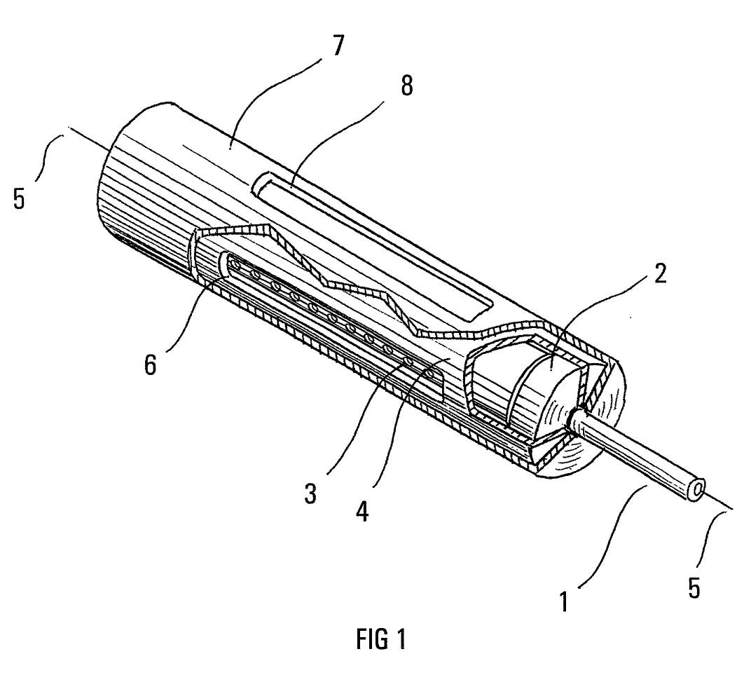

FIG. 1 Illustrates the essence of the preferred embodiment of the invention. A vacuum line 1 provides a vacuum inside a hollow, fixed cylinder 2 into which vacuum supply perforations 3 have been fashioned. A close-fitting cylinder 4 is placed concentrically around fixed cylinder 2 and may be rotated about the common axis 5 of cylinders 2 and 4. Close-fitting cylinder 4 has an axial slot 6 to function as a vacuum orifice. Cylinder 2 therefore acts as a bearing axle with respect to cylinder 4. Concentric and close-fitting cylinder 7, arranged concentrically with cylinders 2 and 4, and rotatable about common axial rotation axis 5, similarly has fashioned into it a slot 8 to act as a vacuum orifice when brought into alignment with slots 3 and 6.

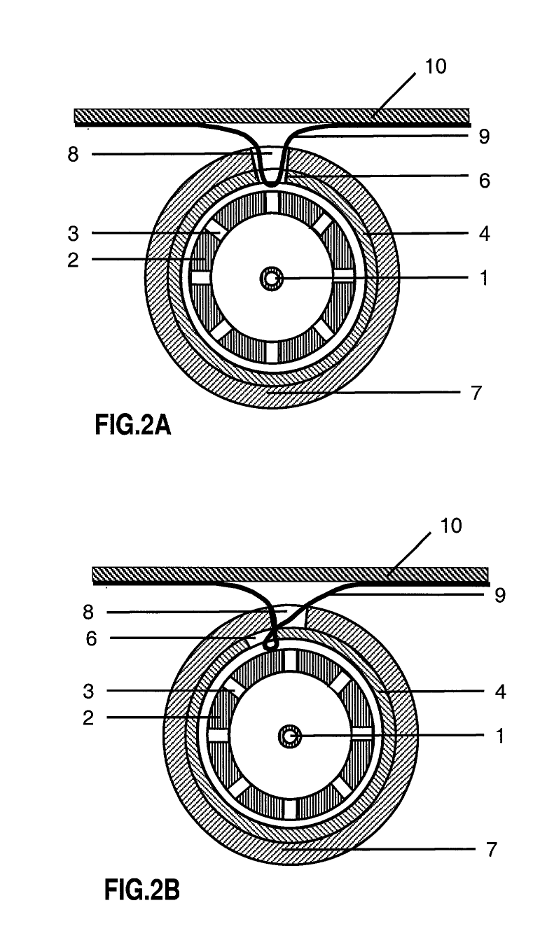

In FIG. 2A, the assembly as described above is brought into the close proximity of thin deformable sheet 9 adhering to the bottom of mechanically sensitive flat sheet 10. The mechanical apparatus or servo-mechanical device that controls and executes this motion is not central to the invention and is not shown. Such apparatus are well known to those skilled in the art. Cylinder 4 and cylinder 7 are rotated, both with respect to cylinder 2 and with respect to each other about their common axis 5 until slots 6 and 8 are mutually aligned and optimally proximate to thin deformable sheet 9. The vacuum produced by the aligned slots 6 and 8 now draw thin deformable sheet 9 into the combined orifices 6 and 8.

When this has been achieved, the two cylinders 4 and 7 are rotated with respect to each other and the thin deformable sheet 8 is mechanically gripped between the opposing edges of the slots 6 and 8. This is depicted in FIG. 2B.

It is evident that the assembly depicted in FIG. 1 may, by the same methods as described above, be placed proximate to a thin deformable sheet (not shown) adhering to the top of mechanically sensitive sheet 10. By rotating the two cylinders 2 and 7 such that the slots 6 and 8 are once again aligned, but, in this case, directed towards this alternative surface, the thin deformable sheet may be drawn in and gripped in the same fashion as described above.

The method therefore represents a means of removing a thin deformable sheet from either surface of a flat sheet without mechanically touching the flat sheet. Having securely gripped the thin deformable sheet on either surface of the flat sheet, it is now possible to remove the thin deformable sheet entirely by mechanically withdrawing the entire assembly of FIG. 1 over an appropriate distance dictated by the physical extent of sheet 10. The vacuum may be off or on after the thin deformable sheet has been gripped mechanically by the two cylinders. The circular cross-section of cylinder 7 and the axial orientation of the slot create a rigid-edge geometry that reliably picks up thin deformable sheets, but will not pick up rigid objects.

By the above method, it is possible to implement the removal of slip-sheets from either side of a mechanically sensitive printing plate. In this case, the rigid edge geometry allows the reliable removal of non-rigid slip-sheet paper, but ensures that the rigid and scratch-sensitive printing plates will not be picked up or touched.

While the cylindrical geometry depicted in the preferred embodiment is simple to implement, there are clearly other geometries that will also achieve the same aim.

In an alternative embodiment, the vacuum may be applied via a different route to the inner of the two orifices.

In yet another embodiment the two outer cylinders are replaced with more generalized mechanical shapes containing orifices that may be aligned.

In yet another embodiment the outer cylinders or mechanical shapes with mutually alignable orifices rotate about a common rotation axis, but as a combination they are rotated or swiveled about a separate axis or point that does not coincide with their common rotation axis.

In yet another embodiment the two cylinders are replaced by flat structures, each with an alignable orifice, that are slid with respect to each other to align slots, with the inner of the two flat structures having vacuum supplied to its orifice.

What is claimed is

1. A method employing a single mechanical arrangement for automatically removing a thin deformable sheet adhering to either face of a substantially flat object.

2. A method as in claim 1, wherein said mechanical arrangement does not make mechanical contact with any point on the surface of said thin deformable sheet while the same point on the opposite surface of said thin deformable sheet is simultaneously in mechanical contact with said substantially flat object.

3. A method as in claim 1 and claim 2, wherein both vacuum and mechanical means are jointly employed.

4. A method as in any of the above claims, wherein said thin deformable sheet is removed by
positioning any part of said thin deformable sheet between at least two opposing mechanical edges and
closing said at least two opposing mechanical edges about any part of said thin deformable sheet located between said at least two opposing mechanical edges.

5. A method as in claim 4, wherein said positioning is performed using vacuum.

6. A method as in claims 4 and 5, wherein said at least two opposing mechanical edges are edges of orifices of any shape fashioned in at least two different close-fitting and mutually movable objects.

7. A method as in claim 6, wherein said at least two different close-fitting and mutually movable objects are mutually rotated about a common axis.

8. A method as in claim 7 wherein said at least two close-fitting and mutually movable objects are concentric cylinders and are rotated about their common axial axis.

9. A method as in claim 8, wherein
said orifices are slots fashioned in the cylindrical surfaces of said concentric cylinders and
said slots are brought into alignment by said rotation of said concentric cylinders about said common axial axis and
said vacuum is established inside the innermost of said cylinders.

10. A method as in claim 9, wherein said substantially flat object is a printing plate and said thin deformable sheet is a slip-sheet

11. A method as in claim 9, wherein said substantially flat object is a photographic plate and said thin deformable sheet is a slip-sheet
